(19) United States
(12) Patent Application Publication
(10) Pub. No.: US 2023/0144511 A1
(43) Pub. Date: May 11, 2023

(54) VACUUM DRYER FOR POLYMER-BASED CONSUMABLES USED IN ADDITIVE MANUFACTURING

(71) Applicant: INDUSTRY SUPPLIES, INC., Newark, DE (US)

(72) Inventor: Martin Fiumura, Buenos Aires (AR)

(21) Appl. No.: 17/523,879

(22) Filed: Nov. 10, 2021

(51) Int. Cl. F26B 21/10; F26B 9/06; F26B 9/08; F26B 21/08

(52) U.S. Cl. CPC F26B 21/10; F26B 9/063; F26B 9/08; F26B 21/083; F26B 2200/08

(57) ABSTRACT

Method, system, and apparatus for drying materials used in additive manufacturing and, more particularly, drying systems which are capable of rapidly drying polymers by alternating heating, and low-pressure cycles without affecting material properties.

### FIELD OF THE INVENTION

This invention relates to drying materials used in additive manufacturing systems, in the form of among others plastic filament, granular resins, liquid resins, plastic, and/or metal powders, prior to the processing thereof into 3D printing equipment.

### BACKGROUND OF THE INVENTION

It is known that polymers absorb ambient moisture. Some resin materials are extremely hygroscopic and become unprocessable by molding or extrusion in ten minutes or less after exiting a dryer, due to the rapid absorption of moisture by the granular resin material. Hence, as a well-known best practice in the plastics manufacturing industry, plastic pellets are preprocessed in order to remove moisture before molding or injection by means of some drying process.

Resin pellet dryers use heat, or vacuum, or a combination of both heat and vacuum. Additionally, some drying devices dry materials by means of a hot gas stream (instead of hot air) due to its greater chemical affinity to absorb moisture. All these methods may vary in cost and efficiency levels.

Nevertheless, the water content in resins combined with high temperature dramatically increases hydrolysis levels. Hydrolysis causes the long monomers and polymers chains to shorten, thus changing the physical properties of plastic materials. Such chemical reaction is usually disregarded in plastic manufacturing since it has no major effects on extrusion or molding, but aesthetic flaws such as bubbles and other imperfections in injected plastic products.

With the fast-growing adoption of additive manufacturing, 3D-printed parts are intended to be used in technical fields. Physical-chemical characteristics of materials are of utmost importance to meet production standards. In fact, recent research studies by the Underwriter Laboratories (UL) highlights the gap in performance between 3D-printed parts versus conventional injection molded and extruded parts.

After being extruded, plastics do not have the same mechanical characteristics of the raw material due to: i) the extrusion process per se; ii) the inherent characteristics of each additive manufacturing technology (FFF, SLS, SLA, etc.), and iii) because of the changes to material chemical properties caused by hydrolysis.

Additive manufacturing systems can use a wide variety of plastic polymers and other consumables. Water absorption is harmful in most of the additive manufacturing technologies such as SLS, where moisture absorption in metallic powders is to be avoided and makes drying a mandatory operation prior to production. Likewise, it affects additive manufacturing technologies which use light to cure resins (SLA). Moisture absorption by plastic materials is a common problem to additive manufacturing materials and technologies, which greatly affect printing quality and machinery efficiency.

Additive manufacturing consumables cannot be efficiently processed by 3D printers until dried. If printed by additive manufacturing machinery before they are dry, moisture in the resin boils when reaching the extrusion temperature in the printer hot end, affecting interlayer adhesion in the printed object or even ruining essential parts of said machinery. Hence, hygroscopic polymer consumables must be dried prior to extrusion in additive manufacturing systems.

Nevertheless, consumables used in additive manufacturing cannot be permitted to soften, since they would become unusable. For instance, once the filament begins to soften at temperatures above the polymer glass transition temperature (Tg), said resin filament melts and gets sticky, making it impossible to utilize the resin material into additive manufacturing machinery.

Drying systems used in additive manufacturing mostly use heat or evaporation drying methods: the material is subjected to the highest possible temperature that can tolerate without reaching its heat deflection temperature (HDT). The material is kept in an environment as dry as possible, where some gas (which can be air or in more expensive methods another gas) is constantly circulating, after being physically or chemically desiccated or both, to gradually remove water from the material.

This method is not very effective and is very inefficient in terms of energy consumption and consumables: for instance, said gas must be dried by filtering the moisture through a membrane or by means of a chemical desiccant.

The material that is not directly exposed to the flow of dry gas has much less probability and tendency to release moisture, and even less when its presentation protects it from heat and said gas. This is the case of a plastic monofilament winded on a spool used in additive manufacturing FFF equipment. Current drying systems adopted in additive manufacturing do not consistently dry material, but only the external winded filament, without reaching its interior. Furthermore, the process takes several hours, from 24 to 72 hrs., for small quantities of material.

Vacuum drying techniques are used in conventional apparatus for drying resin pellets, where the drying period is shortened, achieving a better and more uniform drying pattern in high volumes of resin pellets. The resin pellets are placed in an oven, where they are heated and subjected to vacuum while constantly moving.

However, it would not be possible to use such apparatus and methods to dry additive manufacturing materials like filament spools. In fact, said methods do not consider the conductive component of heat transmission. Under normal conditions, heat flows by conduction, convection, and radiation. In solid plastics, the transmission of heat from the emitting source occurs mainly by convection and to a much lesser extent by radiation. After a given time, all the material reaches the target temperature and, as it loses heat by extracting water, more heat is absorbed quickly and constantly. Nevertheless, there is no heat convection in vacuum, since heat transmission occurs predominantly through radiation.

The chamber heating method influences the heat radiation, as this proves to be effective only if the solid material is directly placed in line with the thermal radiation source. Consequently, only a fraction of a given solid material receives heat by radiation in vacuum, while the material that is not in direct line with the heat source does not heat. This is the case of the filament winded close to the inner hub of a spool. This results in a reduced water extraction efficiency, since energy is not fully available to favor the extraction of water molecules from the material (the extraction benefits from the presence of a greater amount of available energy).

### SUMMARY OF THE INVENTION

The present invention addresses these and other problems by providing a chamber within which temperature and pressure may be precisely controlled to facilitate rapid drying of additive manufacturing consumables placed within the chamber without affecting their properties.

Dryers according to the present invention combine heat and low pressure with chemical desiccants, in order to be more efficient and to reduce all risks inherent to high heat or chemical reactions caused by the presence of water and heat in plastics. Dryers according to the present invention alternate heat and vacuum cycles in sequence so as to achieve significant performance improvement in the drying process.

The present invention relates to drying materials used in additive manufacturing systems, in the shape of plastic filament, granular resins, liquid resins, plastic and/or metal powders, prior to the processing thereof into additive manufacturing equipment.

According to an aspect of the invention, a medium-size drying system is provided which may be suitably employed, for example, to rapidly dry the filament spools used in additive manufacturing.

According to another aspect of the invention, an apparatus and a method are provided to maximize drying efficiency and reduce drying time. The loss of important material physical properties is minimized due to high heat and greatly prevents hydrolysis effects on the polymers and, consequently, on the mechanical characteristics of engineering 3D-printed parts.

In accordance with another aspect of the invention, a method for drying consumables is used in any current or future additive manufacturing technologies, such as plastic filament, granular, resins, powdery plastic resins or metallic material.

According to a preferred embodiment of the invention, the method includes:

(i) heating materials to a preselected temperature at which moisture evaporates from the material when the material is exposed to the preselected temperature;
(ii) generating a level of vacuum for a time sufficient to extract the moisture from the material when exposed to a preselected level of low vacuum pressure and disposing the air containing the extracted moisture;
(iii) allowing a preselected level of air to enter the chamber after being chemically dried;
(iv) alternately controlling the drying heating and/or low-pressure cycles of the method, where in a preferred embodiment it is done sequentially.

According to an aspect of the invention, an apparatus is provided for drying consumables used in any current or future additive manufacturing technologies, such as plastic filament, granular, resins, powdery plastic resins or metallic material, where the apparatus includes at least:

a. at least one sealable chamber (rigid, flexible, or elastic);
b. a sealing element provided to vacuum seal the chamber;
c. a door status sensor;
d. a heating element provided to heat the chamber;
e. a drying element for drying the air inside the chamber;
f. a vacuum generating element provided to create low pressure inside the chamber;
g. a controller for controlling the drying process.

Dryers according to the invention minimize hydrolysis in said consumables and prevents any detrimental consequence caused by heating dryers currently used in additive manufacturing.

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 is a perspective view of a vacuum drying system in accordance with the present invention.

FIG. 2 is a perspective view of a vacuum drying system in accordance with the present invention.

FIG. 3 is a flowchart illustrating the basic steps in the method of drying according to the present invention.

FIG. 4 is a block diagram illustrating the components of the system according to the present invention.

FIG. 5 shows 3D-printed objects in TPU with and without the drying method according to the present invention.

FIG. 6 shows a 3D-printed object in Nylon 6 partially dried according to the present invention.

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

When a material containing moisture is placed in a closed container, the partial pressure of water within said material will tend to equalize with that of its surrounding environment, to a degree conditional to said moisture within the material and the water partial pressure of the environment. This natural tendency of water (and of all liquids in general) is what produces evaporation.

In order to increase evaporation, water requires energy in the form of heat. Water will always tend to equalize the vapor pressure between the water present in the material and the surrounding environment. The rate of said physical reaction depends on several factors: material temperature, the temperature of the surrounding environment, degree of water vapor saturation in the surrounding medium, and the chemical affinity of water molecules with the molecules of the material that contains them (hydrophilic or hydrophobic materials).

The present invention selectively uses heat and vacuum to extract water in materials that have absorbed the water by chemical affinity (hydrophilic materials), that are used for additive manufacturing.

The dryer of the present invention resolves the inefficiency of the drying technologies currently used in additive manufacturing, which deteriorate the properties of costly plastic consumables, by selectively alternating the phases of heat and vacuum in a chemically dried controlled chamber, in order to achieve an efficient drying process of materials used in additive manufacturing. The system and method of the invention provide a decrease in hydrolysis rates and allow the use of lower temperatures.

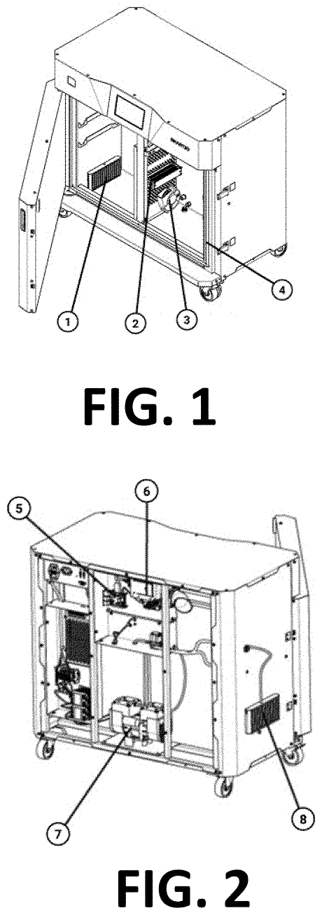

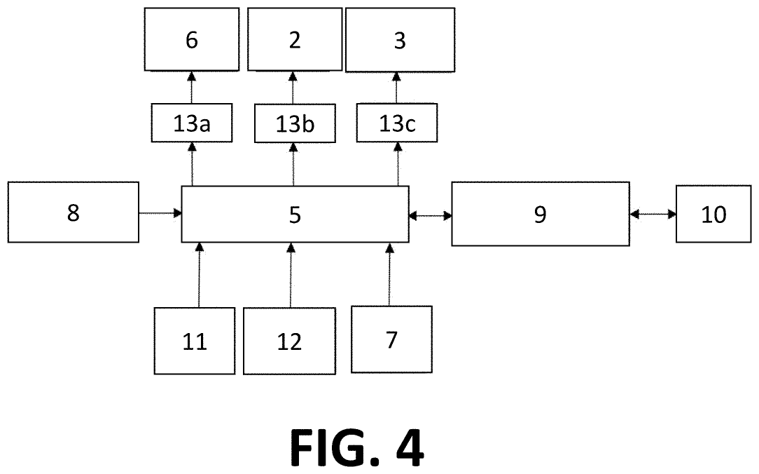

FIGS. 1, 2 and 4 illustrate the dryer system according to an embodiment of the present invention which includes a chemical dessicant (1), a heating element (2), a blower (3), a sealed heated chamber (4), a controller (5), a vacuum pump (6), a temperature sensor (7), a power source (8), a display controller (9), a screen (10), a door sensor (11), a humidity sensor (12), and relays (13a, 13b, 13c) connected to the controller (5) to selectively operate the vacuum pump (6), the heating element (2) and the blower (3), respectively. As can be appreciated, the door sensor senses the status of the chamber door (open or closed) and sends a trigger signal to the controller. The humidity and temperature sensors provide the controller with signals indicative of the temperature and humidity inside the chamber, which are used to selectively carry out the method of the present invention. The display controller allows a user to interact with the controller in order to carry out the method of the present invention as explained below.

Heat Cycle

Consumables are placed in a sealed heated chamber, which preferably includes a door sensor. A heating element and a chemical desiccant are, preferably but not necessarily, positioned within the housing. The heating element can be, for instance, an electrical, ceramic or wire resistor inside the chamber or an infrared heater radiating the outer shell of the chamber, capable of preferably reaching a chamber temperature of around 80° C. Heating cycle achieves a certain temperature, preferably between 45° C. and 80° C.

Heated air is driven by a centrifugal blower in order to maintain constant airflow and to facilitate water particles displacement towards desiccant. In the preferred embodiment, a 50 CFM or higher centrifugal blower evens the air temperature inside the chamber. Alternatively, the blower can be a radial, an axial fan, or a combination of both. The time for preheating is determined by a specified preheat time, which may be entered by an operator into the controller, or by an automatic set-up option in the controller. In the preferred embodiment, set-up preheating time lasts 10 minutes. After said time the material has reached a given temperature homogeneously. Temperature sensors within the chamber monitor air temperature. In the preferred embodiment, temperature sensors are digital, analog, or a combination thereof.

Vacuum Cycle

Once this occurs, a first vacuum drying cycle begins. Each vacuum drying cycle, namely the time a batch of consumable material remains in vacuum chamber under vacuum, has a minimum time that the material is maintained under vacuum. This time may be set by an operator using the inputs available, or a default pre-set time for each polymer. In the preferred embodiment, vacuum cycle durations range from 30 to 50 minutes.

The vacuum forces migration of water particles from the material into the air inside the chamber. During normal operation, vacuum in the vacuum chamber is brought to a specific level set by an operator using the inputs available, or a default pre-set time for each polymer. As a reference, the vacuum inside the chamber specific to each polymer in the preferred embodiment ranges from 300 mbar to 500 mbar. A typical vacuum cycle lasts from 30 to 50 minutes, depending on the material being dried.

According to an embodiment of the invention, vacuum pumps have to be capable of reaching −900 millibars. The vacuum pump can be diaphragm, piston, screw pumps or any combination thereof. After completion of a vacuum cycle in the vacuum chamber, vacuum is broken, and the material is exposed to another heating cycle in order to reach again an homogeneous temperature for a preset duration. In fact, due to heat radiation, parts of the consumable may have higher temperatures while those parts not directly exposed to said heat may have a lower temperature.

The chamber can be equipped with at least one of digital, infrared, or microwave sensors for measuring moisture in the air, the material, or both.

Inlet Air-Drying Cycle

Each vacuum cycle drives humidity from within the material to the air in the chamber. Once air is saturated with moisture, vacuum is broken to evacuate such humidity contained in the air outside the chamber prior to allow entrance of air into the chamber. Air entering the chamber is dried to maintain a dry environment within the chamber and favor the partial pressure gradient of water. Air can be dried either chemically with desiccant, such as silica gel or aluminum-oxide-based compounds, or mechanically through a membrane. Airborne ultrasound can also be applied to enhance and improve the convective drying process.

In the preferred embodiment, during operation of the embodiment of the dryer apparatus, the air entrance to the chamber is equipped with a certain amount of desiccant.

The heat and vacuum cycles are repeated a predetermined number of times, depending on the type of material. Heat, vacuum, and chemical drying cycles are repeated alternately a given number of times depending on the type of plastic consumable.

Variables and factors taken into consideration for carrying out the method of the present invention are, without limitation: type of plastic material, heat temperature, heating time, vacuum duration, pressure gradient, subcycles repetitions.

Automatic pre-set-up options have been validated for several polymers such as ABS, Nylon or PEEK to determine the best pre-settings for each variable (material, chamber temperature, pressure, preheating time, quantity of heat-vacuum cycles) in order to optimize timing and material dryness as in the examples below:

### Example 1

Material: Acrylonitrile butadiene styrene (ABS)
Chamber temperature: 45° C.
Chamber pressure: 500 mbar
Pre-heating time: 10 mins.
Number of subcycles: 5
Drying duration: 40 mins.
Total duration: 3.40 hrs.

### Example 2

Material: polyamide (PA)
Chamber temperature: 80° C.
Chamber pressure: 300 mbar
Pre-heating time: 10 mins.
Number of subcycles: 4
Drying duration: 45 mins.
Total duration: 3.10 hrs.

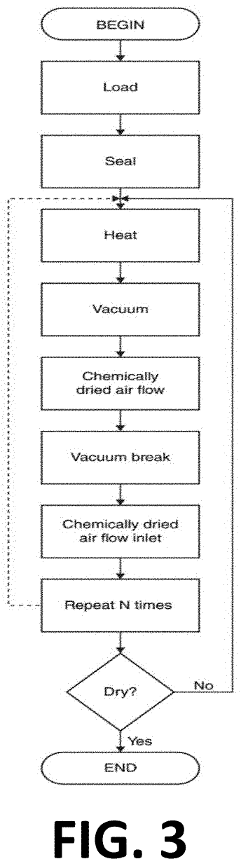

According to an embodiment of the invention as illustrated in FIG. 3, after closing the door, the door sensor is triggered and sensed by the controller. Afterwards, a preheating cycle of 10 minutes starts to achieve the preset chamber temperature. When chamber temperature is reached, the vacuum pump is activated to achieve the preset chamber pressure gradient for the preset drying duration while expelling the air in the chamber. Chamber pressure is then broken while preset temperature is maintained during the 10-minute preheating subcycle, so to allow air to enter the chamber after being chemically dried. Vacuum and no vacuum subcycles are repeated a preset number of times. Chamber preset temperature is maintained even throughout the whole process thanks to the centrifugal blower.

Dryers according to the invention shorten drying time relative to heating dryers, thereby avoiding prolonged exposure of the plastic consumables to heat. This helps to maintain desired physical properties of the material.

Dryers in accordance with the invention minimize the need to expose material to be dried to high heat for extended periods, dramatically eliminating or minimizing hydrolysis, which some materials experience when exposed to high heat for extended periods.

Dryers in accordance with the invention permit drying of plastics at lower temperatures than known heretofore. PEEK heretofore has had to be dried at about at least 110° C., but with dryers in accordance with the present invention PEEK can be dried at 80° C.

No cooling water is required for the dryers in accordance with the invention. The dryers of the invention do not require and do not utilize a dew point meter or a dew point control, both of which are subject to reliability problems, but are necessary with desiccant dryers.

Dryers in accordance with the invention uniformly and consistently exhibit a great reduction in drying time over that experienced using conventional heat dryers when drying material consumables prior to extrusion in additive manufacturing equipment. Such conventional dryers rely entirely on blowing warm air over the plastic material and having the warm, dried air absorb moisture out of the plastic material of interest.

Vacuum drying technique is used to shorten the drying period and achieve a better and more uniform drying pattern in high volumes of material. The combination of vacuum, heat, and subcycles repetition achieves significantly shorter drying times and maximizes moisture removal compared to high heat alone.

The following table shows comparative drying results for different materials:

| | Weight | | Weight | |
|---|---|---|---|---|
| | before | | after | Moisture |
| Material | drying (g) | Preset program | drying (g) | extracted (g) |
| Sample 1: | 808 | Standard (40° C.) | 802 | 6 |
| Nylon | | | | |
| 6/66/12 | | | | |
| Nylon | 802 | Nylon (80° C.) | 792 | 10 |
| 6/66/12 | | | | |
| Sample 2: | 808 | Nylon (80° C.) | 787 | 21 |
| Nylon 6 | | | | |
| Sample 3: | 1015 | Standard (40° C.) | 1004 | 11 |
| Nylon 6 | | | | |
| Nylon 6 | 1004 | Nylon (80° C.) | 986 | 18 |
| Sample 4: | 947 | Nylon industrial | 922 | 25 |
| Nylon 6 | | (80° C.) | | |
| Sample 5: | 861 | Standard (40° C.) | 853 | 8 |
| Nylon 6 | | | | |
| Nylon 6 | 853 | Standard (40° C.) | 843 | 10 |
| Nylon 6 | 843 | Nylon (80° C.) | 837 | 6 |

In conventional dryers used in injection molding industrial lines, pellets are dried into ovens for several hours. Heat causes the molecules to move about more vigorously, weakening the forces that bind the water molecules to the polymer chains. Above certain temperatures, the force that binds water molecules to the polymer chains is reduced, thus permitting free movement of the molecules, and allowing the drying process. Drying temperatures are usually up to 150-180° F., but no higher since many granular resin materials begin to soften at 200-210° F.

Test data reveals that operating costs of dryers according to the invention are less than one-half that of a desiccant dryer having the same capacity. In many cases operating cost is reduced by as much as 80% over that of a desiccant dryer having the same capacity.

Tests conducted with samples containing around 95% of water were successfully dried in around 19 hrs with a pre-set drying program. Dried samples contain less than 10% of water.

The pre-set drying program being:

Chamber temperature: 80° C.
Chamber pressure: 300 mbar Pre-heating time: 10 mins.
Number of subcycles: 23
Drying duration: 50 mins.
Total duration: 19.30 hrs.

Startup time in a dryer in accordance with the invention is under one hour, whereas typical desiccant dryers require four hours or more for a startup.

Additionally, dryers according to the invention allow drying different polymers at the same time in a shorter time. This is an extremely convenient advantage in additive manufacturing, where multiple materials are used and need to be dried in the shortest time possible before each print.

Another important advantage of the invention is that plastic resin material being dried is exposed to a much lower heat than with known methods, thereby reducing the risk of plastic degradation due to heat exposure and hydrolysis incidence. Many additive manufacturing materials, especially more expensive materials, are highly sensitive to exposure to heat, even more in the form of 1.75 mm filament. These materials, commonly referred to as “engineering” materials, include among others nylon, PET, and various polycarbonates.

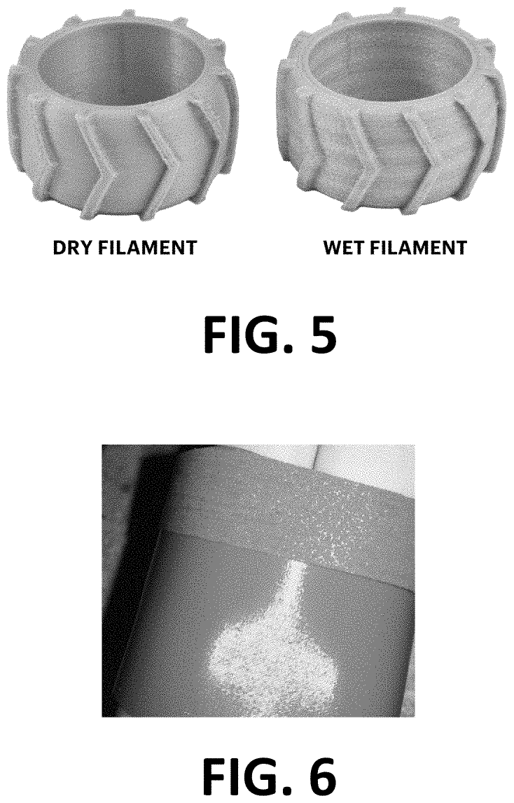

FIG. 5 shows a comparison between two 3D-printed objects in TPU. The object on the right was printed with material not dried in the system of the present invention. As can be appreciated, there are clear chromatic variations, texture, surface, and, consequently, the measures of the object are inconsistent. In contrast, the object on the left was printed with material properly dried using the system of the present invention. Surface and terminations are smoother and result in more precise definition and measures of the object.

A 3D-printed object in Nylon 6 is shown in FIG. 6. The upper part shows humidity, which greatly affects the mechanical characteristics of the polymer. The bottom part has been printed with filament dried in the dryer of the present invention. As can be appreciated, the upper part has an uneven surface and it is easily breakable, bwhereas the lower part has a smooth surface.

The foregoing describes the preferred embodiment of the invention and sets forth the best mode contemplated for carrying out the invention in such terms as to facilitate the practice of the invention by a person of ordinary skill in the art. However, it is to be understood that the invention has many aspects, is not limited to the structure, processes, methods, and embodiment disclosed and/or claimed, and that equivalents to the disclosed structure, processes, methods, embodiment, and claims are within the scope of the invention as defined by the claims appended hereto or added subsequently.

Although the present invention has been described herein with reference to the foregoing exemplary embodiment, this embodiment does not serve to limit the scope of the present invention. Accordingly, those skilled in the art to which the present invention pertains will appreciate that various modifications and equivalents are possible, without departing from the technical spirit of the present invention.

1. A vacuum drying apparatus for drying plastic filament, granular, powdery plastic resins or metallic material comprising:
a sealed chamber.
a sensing element for measuring a temperature at a position inside said sealed chamber;
a heating element for heating said sealed chamber prior to drying;
an airflow directing element for keeping a temperature and humidity homogeneous inside said sealed chamber;
a vacuum generating element for generating vacuum within said sealed chamber at said position; and
a chemical desiccant for drying air entering the sealed chamber prior to the vacuum generation.

2. The low-pressure apparatus according to claim 1, wherein said sealed chamber is pressure resistant.

3. The low-pressure apparatus according to claim 1, wherein said sensing element is a temperature sensor.

4. The low-pressure apparatus according to claim 1, wherein said heating element is a heating resistor.

5. The low-pressure apparatus according to claim 1, wherein said airflow directing element is a blower.

6. The low-pressure apparatus according to claim 5, wherein said blower comprises a centrifugal blower.

7. The low-pressure apparatus according to claim 1, wherein said vacuum generating element is a vacuum pump.

8. The low-pressure apparatus according to claim 1, wherein said chemical desiccant is provided on a cartridge.

9. The low-pressure apparatus according to claim 1, further comprising a control unit connected to said sensing element, said heating element, said airflow directing element and said vacuum generating element.

10. A method for drying material used in additive manufacturing, said method comprising:
heating air inside a sealed chamber configured to contain a material used in additive manufacturing;
monitoring a temperature inside said sealed chamber and regulating the heating of air to ensure that said temperature does not exceed a predefined temperature;
directing said heated air through the material; and
generating a vacuum inside said sealed chamber so that said material is dried.

11. The method according to claim 1, wherein the air inside said sealed chamber is heated to a desired temperature based on said material.

12. The method according to claim 1, wherein the vacuum generated inside said sealed chamber reaches a predefined level of vacuum to evaporate moisture from said heated material to a desired level of dryness.

13. The method according to claim 12, wherein said predefined level of vacuum is maintained for an amount of time needed to evaporate said moisture from the heated material.

14. The method according to claim 1, further comprising monitoring an air temperature exiting said sealed chamber.

15. The method according to claim 1, further comprising drying air entering said sealed chamber.

16. The method according to claim 15, wherein the air entering said sealed chamber is preferably chemically dried.

17. The method according to claim 1, further comprising repeating the steps of heating the air inside the sealed chamber and the step of generating a vacuum inside said sealed chamber alternately until said material reaches a desired level of dryness.

18. The method according to claim 15, further comprising selectively repeating the steps of drying the air entering said sealed chamber, heating the air inside the sealed chamber and generating a vacuum inside said sealed chamber until said material reaches a desired level of dryness.
